(19) United States
(12) Patent Application Publication
(10) Pub. No.: US 2009/0031531 A1
(43) Pub. Date: Feb. 5, 2009

(54) Arresting Device for Hinge Assembly Structure

(76) Inventors: Kuo-Feng CHANG, Sinjhuang City (TW); Chen Hao Wu, Sinjhuang City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 12/184,789

(22) Filed: Aug. 1, 2008

(30) Foreign Application Priority Data
Aug. 1, 2007 (TW) 096212604

(51) Int. Cl. E05D 13/00

(52) U.S. Cl. 16/333

(57) ABSTRACT

The present invention is to provide an arresting device for hinge assembly structure, comprising a fixed part and a movable part assembled together and then connected with the pivot such that the movable part can be rotated with respect to the fixed part; an engagement assembly in which a rotation base disposed with an engagement portion at its outer side is securingly disposed at the outer side of the movable part for the insertion of the pivot, a slide base disposed with a retention portion at its inner side corresponding to the engagement portion is abuttingly connected onto the outer side of the rotation base, also for the insertion of the pivot, and moved integratedly with the rotation base, and a resilient part disposed at the hollow seat chamber between the two bases for the insertion of the pivot; consequently, when the outer side of the slide base is applied with an external force from a compression member, the slide base moves toward the rotation base and compress the resilient part, such that the retention portion at the inner side of the slide base and the engagement portion of the rotation base are interlacingly engaged to form an arresting status.

### FIELD OF THE INVENTION

The present invention relates to an arresting device, and more particularly to an arresting device for hinge assembly structure.

### BACKGROUND OF THE INVENTION

It is common to see two objects being rotated angularly relative to each other to open or close, door panel for example. On the other hand, it is also common to see devices which are flipped open to operate or closed to power off, commonly seen portable computer, electronic dictionary, portable audio/video player, and so on for example.

A hinge is usually used for such a device for adjusting the relative angle between two objects involved. In a portable computer, it is usually called hinge assembly or pivotal device for such a purpose. Regardless of hinge assembly or pivotal device, they both make use of torsion or friction. Basically, an engagement assembly, frictional element or cam element, is provided on each of the two objects to position the flipping open/closed by reaching an engagement between them.

Recently, flat panel displays, such as liquid crystal display (LCD) monitors, LCD TVs, or plasma TVs, have the advantages of lightweight, thinness, and radiation-free and thus have gradually replaced conventional cathode ray tube (CRT) monitors. Consequently, a supporting element with a hinge assembly has become an essential accessory for flat panel displays.

A hinge assembly in general comprises a fixed part, a base for example, and a movable part, an angle-restricting structure disposed in a flat panel display, so as to adjust the flat display panel with respect to the base within a certain range of angles. In fact, when the flat display panel is adjusted to a certain degree with respect to the base, it is required to maintain a secured and immovable condition, i.e. an arresting device is needed to lock the base and flat display panel into a secured engagement. However, the conventional hinge assembly can only provide the function of restricting angle, but the arresting function described above is still not available. Thus the application of the hinge assembly has been restricted significantly, and further improvements are needed.

### SUMMARY OF THE INVENTION

In view of the foregoing shortcomings of the prior art, the inventor of the present invention based on years of experience in the related industry to conduct extensive researches and experiments, and finally invented an arresting device for hinge assembly structure in accordance with the present invention.

In order to accomplish the objectives described above, the present invention is to provide an arresting device for hinge assembly structure, comprising a fixed part and a movable part assembled together and then connected with a pivot such that the movable part can be rotated with respect to the fixed part; an engagement assembly in which a rotation base disposed with an engagement portion at its outer side is securingly disposed at the outer side of the movable part for the insertion of the pivot, a slide base disposed with a retention portion at its inner side corresponding to the engagement portion is abuttingly connected onto the outer side of the rotation base, also for the insertion of the pivot, and moved integratedly with the rotation base, and a resilient part disposed at the hollow seat chamber between the two bases for the insertion of the pivot; consequently, when the outer side of the slide base is applied with an external force from a compression member, the slide base moves toward the rotation base and compress the resilient part, such that the retention portion at the inner side of the slide base and the engagement portion of the rotation base are interlacingly engaged to form an arresting status.

Another objective of the present invention is to provide an arresting device for hinge assembly structure, wherein the engagement portion disposed at its outer side the rotation base is fabricated to form a plurality of engagement teeth formed in a ring and the retention portion disposed at the inner side of the slide portion corresponding to the engagement teeth of the engagement portion is fabricated to form a plurality of retention teeth, such that the engagement teeth and the retention teeth can be engaged or disengaged.

A further objective of the present invention is to provide an arresting device for hinge assembly structure, wherein at least two engagement tenons are formed at the inner circumference of the rotation base to engagingly insert into the tenon slots correspondingly disposed at the movable part so as to move integratedly.

Another further objective of the present invention is to provide an arresting device for hinge assembly structure, wherein the compression member is a handle whose cams at its top is pivotally connected with the outer end of the pivot, such that when the handle plate disposed at the lower end of the handle is pulled to switch between the long sides and short sides of the cams, a lateral pressure can be exerted at or relieved from the slide base.

A further objective of the present invention is to provide an arresting device for hinge assembly structure, wherein the compression member is a rotation member or a two-stage fastening member.

A further objective of the present invention is to provide an arresting device for hinge assembly structure, wherein at least a torsion spring is socketingly connected with the pivot between the movable part and the fixed part with two ends of the torsion spring being abutted against the movable part and the fixed part, respectively, and the torsion spring is fitted into a tube and then is inserted with the pivot.

### BRIEF DESCRIPTION OF THE DRAWINGS

FIG. 1 is an exploded view of an arresting device for hinge assembly structure of the present invention;

FIG. 2 is a perspective assembly view of FIG. 1;

FIG. 3 is a cross-sectional view of Section A-A as depicted in FIG. 2;

FIG. 4 is a perspective view of an arresting device of the present invention in a unlocked status; and

FIG. 5 is a cross-sectional view of Section B-B as depicted in FIG. 4.

### DETAILED DESCRIPTION OF THE PREFERRED EMBODIMENTS

The structure, technical measures and effects of the present invention will now be described in more detail hereinafter with reference to the accompanying drawings that show various embodiments of the invention.

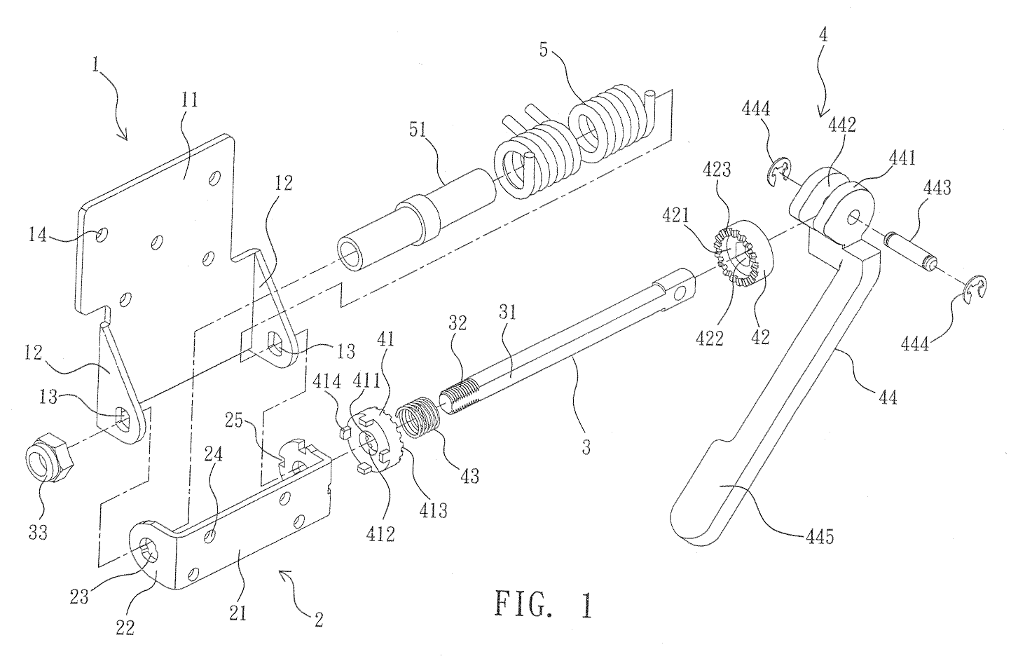

Referring to FIG. 1, a hinge assembly of the present invention comprises a fixed part 1, a movable part 2, a pivot 3, and an engagement assembly 4, wherein the fixed part 1 and the movable part 2 are conventional arts, which are assembled together and then connected with the pivot 3. Consequently, the movable part 2 can be rotated with respect to the fixed part 1 to adjust the opening angle between them.

The fixed part 1 is a plate body having a base plate 11 extending from either side to form a pair of wing plates 12, on which two oppositely located connection holes 13 are fabricated for the insertion of the pivot 3, wherein the base plate 11 is fabricated on its surface to form a plurality of through which connecting elements, screws for example, can be inserted and fastened onto the base

The movable part 2 is a horizontal frame plate 21 perpendicularly disposed with a pair of protruding ears 22 on either side, which are abuttingly connected with the wing plates 12, respectively. The protruding ears 22 are fabricated to form an axial hole 23, respectively, corresponding to the location of the connection holes 13, such that the pivot 3 can be inserted and connected thereon. The frame plate 21 is fabricated on its surface to form a plurality of plate holes 24 through which connecting elements, screws for example, can be inserted and connected onto a supporting element, the lower end of a connecting plate, for example, whose upper end is further connected with a liquid crystal display.

In fact, the fixed part 1 and the movable part 2 can be fabricated with different fashions into a base and a supporting element. However, it is a conventional art and will not be discussed here furthermore.

The pivot 3 is a bar body inserted through the connection holes 13 of the fixed part 1 and the axial holes of the movable holes 2, and the movable part 2 can be rotated with respect to the fixed part 1 to provide the function of a hinge assembly. With reference to the figures, the bar body of the pivot 3 is fabricated to form a pair of corresponding flat faces 31. The shape and size of the connection holes 13 conform to the cross-section of the pivot 3, and the connection segment 32, a screw segment for example, formed at the free end of the pivot 3 is connected with an end cap 33, a self-locking nut for example, at the outer side of the connection holes 13 of the wing plate 12 of the fixed part 1.

The engagement assembly 4 comprises a rotation base 41, a slide base 42, a resilient part 43, and a compression member 44. The rotation base 41 is securingly disposed at the outer side of one protruding ear 22 of the movable part 2, wherein a through hole 412 is fabricated at the inner side of a hollow seat chamber 411 at the inner side of the rotation base 41 for the insertion of the pivot 3. Also, the external circumference of the rotation base 41 is formed to have a plurality of engagement teeth 413 and at least two engagement tenons 414 are formed at its inner circumference to engagingly insert into the tenon slots 25 correspondingly disposed at the protruding ear 22 and thus the rotation base 41 is securingly disposed at the outer side of the protruding ear 22, such that the rotation base 41 and the protruding ear 22 can move integratedly. Further, a through hole 422 is fabricated at the center of the hollow seat chamber 421 of the slide base 42 for the insertion of the pivot 3. The circumference of the inner side of the slide base 42 corresponding to the engagement teeth 413 is disposed a plurality of retention teeth 423. Also, the space between the hollow seat chambers 411 and 421 is disposed with the resilient part 43, a spring for example. Consequently, when the slide base 42 is applied with a lateral force from the compression member 44, the slide base 42 moves toward the rotation base 41 and compresses the resilient part 43, such that the retention teeth 423 on its inner circumference are interlacingly engaged with the engagement teeth 413 to form a locking status through arresting.

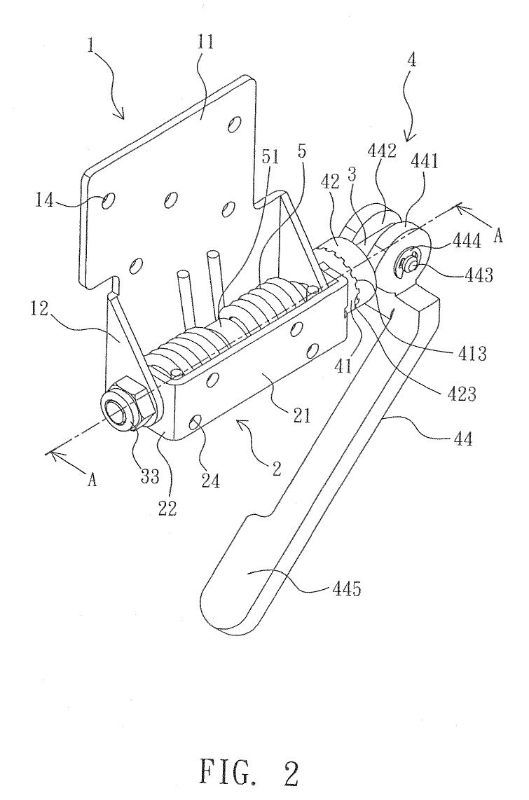

With reference to FIG. 1, the generation of the lateral force is through the compression member 44. A wheel groove 442 between the two cams 441 at the top of the compression member 44, a handle for example, is socketingly connected with the external end of the pivot 3 with a pivot pin 443 to pivotally connect with the pivot 3, and retainers 444 are retained on both sides of the pivot pin 443 so as to prevent the compression member 44 from disconnecting from the pivot 3. With a pushing force applied on the handle plate 445, the cams 441 rotate from their short sides to long sides such that move the slide base 42 is moved toward and connected with the rotation base 41. The perspective view of the connection is shown in FIG. 2, wherein the shape of the compression member 44 is not limited to the cam structure shown in FIGS. 1 and 2. When the present invention being implemented, the compression member 44 can be a rotation member, a rotation cover for example, or a two-stage fastening member, a push bottom structure for example, to achieve the same function.

Further, to render the movable part 2 capable to support certain supported objects, a supporting member and liquid crystal display for example, at least a torsion spring 5 is socketingly connected with the pivot 3 between the movable part 2 and the fixed part 1 with two ends of the torsion spring 5 being abutted against the movable part 2 and the fixed part 1, respectively. Also, the torsion spring 5 is fitted into a tube 51, which are then inserted with the pivot 3 so as to prevent the interference between the torsion spring 5 and the pivot 3.

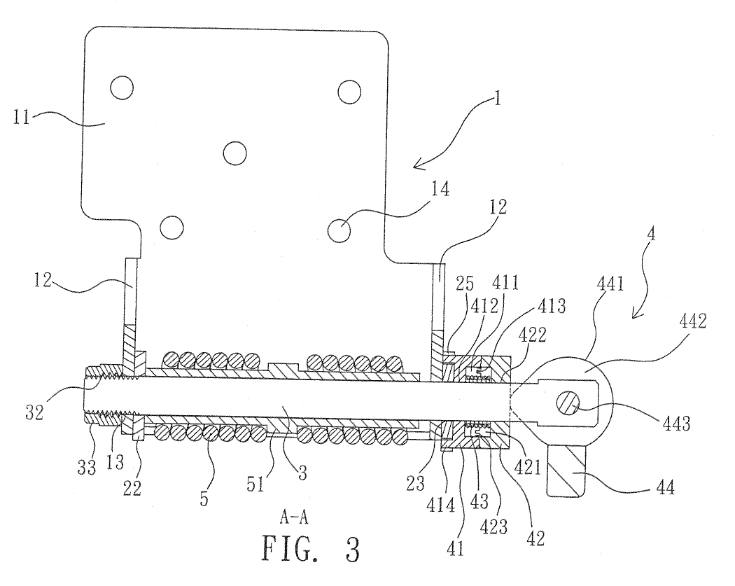

With reference to FIG. 3, which is a cross-sectional view taken from the A-A line in FIG. 2, the long sides of the cams 441 of the compression member 44 exert a lateral pressure toward the slide base 42 and, in the mean time, compress the resilient part 43 to render the retention teeth 423 and the engagement teeth 413 engaged together. Since the pivot 3 is connected with the fixed part 1 to be in a securing status and the movable part 2 is laterally connected with the rotation base 41 which is engaged with the slide base 42 to become engaged and locked, the movable part 2 cannot rotate on the pivot 3.

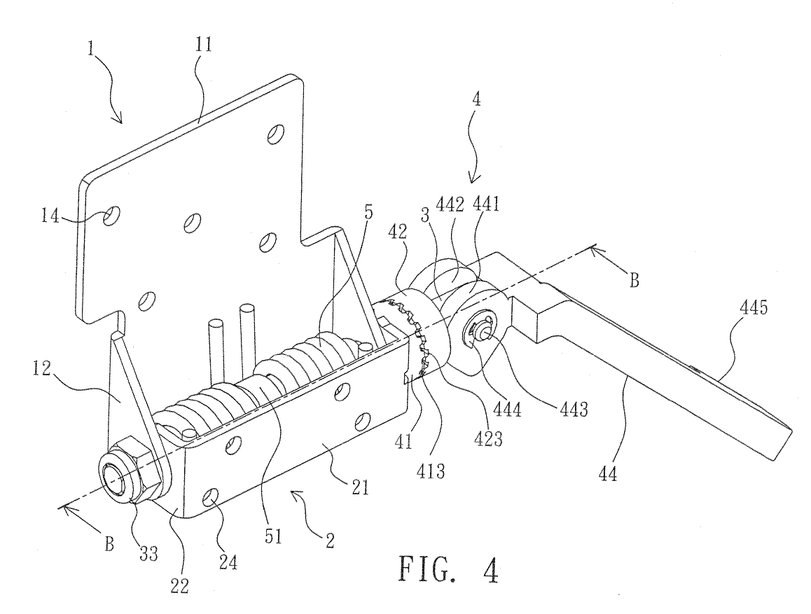

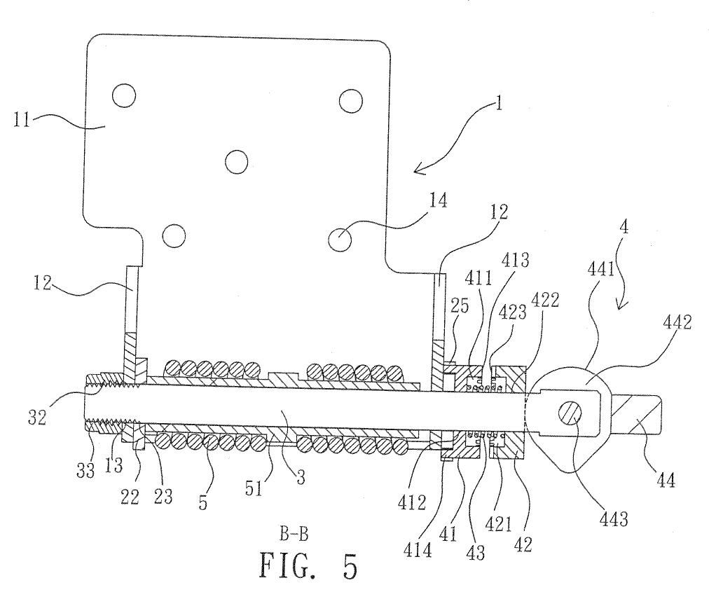

With reference to FIGS. 4 and 5, unlocking can be achieved by pulling the compression member 44 to change the long sides of the cams 441 to their short sides. The slide base 42, without the pushing force, slides outwards under the extension force of the resilient part 43 to disconnect the retention teeth 423 from the engagement teeth 413, so as to be released from the engagement. Also, the movable part 2 along with the rotation base 41 is able to rotate on the pivot 3 so as to be released from the locking engagement.

With the implementation of the present invention by incorporating an engagement assembly into a hinge assembly, the application of force on the compression member moves the slide base of the engagement assembly from a first position to second position and, with the slide base securingly disposed at one side of the movable part, form an engagement to provide a blocking function. If a disengagement status is required, a revere force should be applied on the compression member to return the slide base back to the first position from the second position so as to achieve a unlocking effect. Further, at least a resilient supporting element, torsion spring for example, is disposed between the fixed part and the movable part to support the supported objects, which is indeed a novel approach not seen in the field.

The present invention provides a feasible solution, and a patent application is duly filed accordingly. However, it is to be noted that the preferred embodiments disclosed in the specification and the accompanying drawings are not intended to limit the invention. To the contrary, it is intended to cover various modifications and similar arrangements and procedures, and thus the scope of the appended claims should be accorded the broadest interpretation so as to encompass all such modifications and similar arrangements and procedures.

What is claimed is:

1. An arresting device for hinge assembly structure, comprising
a fixed part and a movable part assembled together and then connected with the pivot such that the movable part can be rotated with respect to the fixed part;
an engagement assembly in which a rotation base disposed with an engagement portion at its outer side is securingly disposed at the outer side of the movable part for the insertion of the pivot, a slide base disposed with a retention portion at its inner side corresponding to the engagement portion is abuttingly connected onto the outer side of the rotation base, also for the insertion of the pivot, and moved integratedly with the rotation base, and a resilient part disposed at the hollow seat chamber between the two bases for the insertion of the pivot; consequently, when the outer side of the slide base is applied with an external force from a compression member, the slide base moves toward the rotation base and compress the resilient part, such that the retention portion at the inner side of the slide base and the engagement portion of the rotation base are interlacingly engaged to form an arresting status.

2. The arresting device for hinge assembly structure as claimed in claim 1, wherein the engagement portion disposed at its outer side the rotation base is fabricated to form a plurality of engagement teeth formed in a ring and the retention portion disposed at the inner side of the slide portion corresponding to the engagement teeth of the engagement portion is fabricated to form a plurality of retention teeth, such that the engagement teeth and the retention teeth can be engaged or disengaged.

3. The arresting device for hinge assembly structure as claimed in claim 1, wherein at least two engagement tenons are formed at the inner circumference of the rotation base to engagingly insert into the tenon slots correspondingly disposed at the movable part so as to move integratedly.

4. The arresting device for hinge assembly structure as claimed in claim 1, wherein the compression member is a handle whose cams at its top is pivotally connected with the outer end of the pivot, such that when the handle plate disposed at the lower end of the handle is pulled to switch the long sides and short sides of the cams, a lateral pressure can be exerted at or relieved from the slide base.

5. The arresting device for hinge assembly structure as claimed in claim 1, wherein the compression member is a rotation member.

6. The arresting device for hinge assembly structure as claimed in claim 1, wherein the compression member is a two-stage fastening member.

7. The arresting device for hinge assembly structure as claimed in claim 1, wherein at least a torsion spring is socketingly connected with the pivot between the movable part and the fixed part with two ends of the torsion spring being abutted against the movable part and the fixed part, respectively.

8. The arresting device for hinge assembly structure as claimed in claim 7, wherein the torsion spring is fitted into a tube and then is inserted with the pivot.

9. The arresting device for hinge assembly structure as claimed in claim 1, wherein the fixed part is a plate body having a base plate extending from either side to form a pair of wing plates, on which two correspondingly located connection holes are fabricated for the insertion of the pivot and the movable part is a horizontal frame plate perpendicularly disposed at its two sides with a pair of protruding ears, which are abuttingly connect with the wing plate and fabricated to form an axial hole, respectively, corresponding to the location of the connection holes for the insertion of the pivot.
